(19) United States
(12) Patent Application Publication
(10) Pub. No.: US 2025/0227736 A1
(43) Pub. Date: Jul. 10, 2025

(54) COMMUNICATION METHOD AND APPARATUS, AND COMPUTER READABLE STORAGE MEDIUM

(71) Applicant: XI’AN UNISOC TECHNOLOGIES CO., LTD., Xi’an, Shaanxi (CN)

(72) Inventors: Haowen LIU, Xi'an, Shaanxi (CN); Mimi CHEN, Xi'an, Shaanxi (CN)

(21) Appl. No.: 18/563,423

(22) PCT Filed: Jul. 19, 2023
(86) PCT No.: PCT/CN2023/108119

§ 371 Date: Nov. 22, 2023

(30) Foreign Application Priority Data
Jul. 22, 2022 (CN) 202210871132.6

(51) Int. Cl. H04W 72/40; H04L 1/1812

(52) U.S. Cl. CPC H04W 72/40; H04L 1/1812

(57) ABSTRACT

A communication method and apparatus, and a computer readable storage medium are provided. The communication method includes: receiving scheduling information, wherein the scheduling information indicates a transmission resource of a sidelink, and the transmission resource corresponds to at least two Physical Sidelink Feedback CHannels (PSFCHs); and determining a reference time unit based on the at least two PSFCHs, wherein the reference time unit is used to determine a sending time unit of Hybrid Automatic Repeat reQuest-ACKnowledgement (HARQ-ACK) information, and the HARQ-ACK information indicates a reception status of the sidelink.

### CROSS-REFERENCE TO RELATED APPLICATIONS

This is the U.S. national stage of application No. PCT/CN2023/108119, filed on Jul. 19, 2023. Priority under 35 U.S.C. § 119 (a) and 35 U.S.C. § 365 (b) is claimed from Chinese Application No. 202210871132.6, filed Jul. 22, 2022, the disclosure of which is also incorporated herein by reference.

### TECHNICAL FIELD

The present disclosure generally relates to radio communication technology field, and more particularly, to a communication method and apparatus, and a computer readable storage medium.

### BACKGROUND

In a Sidelink operation in Unlicensed spectrum (SL-U) system, multiple Physical Sidelink Feedback Channels (PSFCHs) may correspond to a same transmission resource, which ensures a transmitting device's reception of Hybrid Automatic Repeat reQuest-ACKnowledgement (HARQ-ACK) messages.

### SUMMARY

Embodiments of the present disclosure may ensure that a terminal device and a network device transmit and receive HARQ-ACK information respectively in a same time unit in an SL-U system where one transmission resource is supported to be associated with multiple PSFCHs for HARQ-ACK information feedback.

In an embodiment of the present disclosure, a communication method is provided, including: receiving scheduling information, wherein the scheduling information indicates a transmission resource of a sidelink, and the transmission resource corresponds to at least two PSFCHs; and determining a reference time unit, wherein the reference time unit is used to determine a sending time unit of HARQ-ACK information, and the HARQ-ACK information indicates a reception status of the sidelink.

In an embodiment of the present disclosure, a non-volatile or non-transitory computer readable storage medium having computer instructions stored therein is provided, wherein when the computer instructions are executed by a processor, any one of the above communication methods is performed.

In an embodiment of the present disclosure, a communication apparatus including a memory and a processor is provided, wherein the memory has computer instructions stored therein, and when the processor executes the computer instructions, any one of the above communication methods is performed.

### BRIEF DESCRIPTION OF THE DRAWINGS

FIG. 1 is a schematic diagram of a potentially feasible time sequence relationship;

FIG. 2 is a schematic diagram of a time sequence relationship of an existing HARQ-ACK information reporting method;

FIG. 3 is a schematic diagram of a time sequence relationship of a potentially feasible HARQ-ACK information reporting method;

FIG. 4 is a flow chart of a communication method according to an embodiment;

FIG. 5 is a diagram of an application scenario according to an embodiment;

FIG. 6 is a schematic diagram of a time sequence relationship between acquisition and reporting of HARQ-ACK information according to an embodiment;

FIG. 7 is a schematic diagram of a time sequence relationship between acquisition and reporting of HARQ-ACK information according to an embodiment;

FIG. 8 is a flow chart of a communication method according to an embodiment;

FIG. 9 is a block diagram of a communication apparatus according to an embodiment; and

FIG. 10 is a block diagram of a communication apparatus according to an embodiment.

### DETAILED DESCRIPTION

In New Radio (NR) sidelink (SL) resource allocation mode 1, sidelink transmission resources are configured by a network device. A transmitting device indicates whether sidelink data has been received correctly by reporting sidelink HARQ-ACK information to the network device. The network device determines whether to allocate additional retransmission resources based on the HARQ-ACK information.

In the SL-U system, Listen-Before-Talk (LBT) needs to be performed before data transmission. Data is allowed to be sent when LBT succeeds. If LBT fails, no information can be sent. An existing NR standard stipulates that one transmission resource corresponds to one unique PSFCH for carrying HARQ-ACK information. If the LBT fails before the PSFCH, the HARQ-ACK information cannot be sent, which seriously affects reliability of the HARQ-ACK information.

One improved solution in response to the above issue includes adding additional PSFCHs in different slots to correspond to a same transmission resource, so as to ensure that the transmitting device receives the HARQ-ACK information.

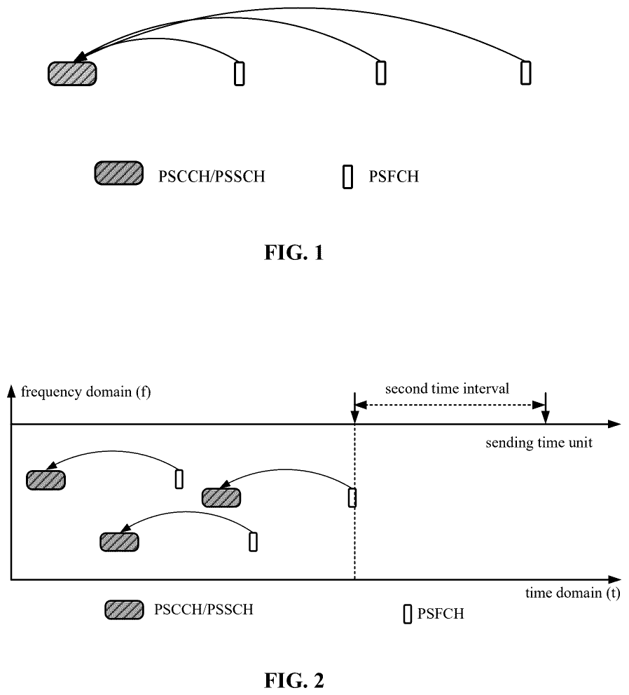

Referring to FIG. 1, FIG. 1 is a schematic diagram of a potentially feasible time sequence relationship. In FIG. 1, a Physical Sidelink Shared Channel (PSSCH)/Physical Sidelink Control Channel (PSCCH) is associated with 3 PSFCHs for HARQ-ACK information feedback, and the 3 PSFCHs are distributed in different slots.

Based on the existing standard, when receiving HARQ-ACK information feedback from a receiving device (RxUE), a transmitting device (TxUE), based on a current resource scheduling mode, follows instructions in Downlink Control Information (DCI) or preconfiguration information in Radio Resource Control (RRC) signaling, and accordingly determines a time interval between a time unit in which the transmitting device receives the HARQ-ACK information feedback from the receiving device, and a time unit in which the transmitting device feeds back the HARQ-ACK information to the network device, where the time unit in which the transmitting device feeds back the HARQ-ACK information uplink to the network device is uniquely determined. The time unit in which the transmitting device receives the HARQ-ACK information feedback from the receiving device is a reference time unit corresponding to the time unit in which the transmitting device transmits the HARQ-ACK information to the network device.

Referring to FIG. 2, FIG. 2 is a schematic diagram of a time sequence relationship of an existing HARQ-ACK information reporting method.

In FIG. 2, a network device schedules three times of PSSCH/PSCCH transmission. Each PSSCH/PSCCH transmission determines, according to an existing standard, a unique PSFCH used for a receiving device transmitting HARQ-ACK information to a transmitting device. The transmitting device uses a slot of the PSFCH where the HARQ-ACK information corresponding to the last transmission is received as a reference time unit, uniquely determines the time unit for NR sidelink HARQ-ACK information uplink feedback (i.e., the sending time unit) based on a PSFCH-to-HARQ feedback timing indicator field in DCI or high-layer parameters configured in RRC signaling, and feeds back the HARQ-ACK information to the network device. A time interval between the sending time unit and the reference time unit is a second time interval.

When considering the technical solution shown in FIG. 1 in an existing technology scenario shown in FIG. 2, it is found that the network device cannot determine a real time when the transmitting device reports the HARQ-ACK information. Referring to FIG. 3, FIG. 3 is a schematic diagram of a time sequence relationship of a potentially feasible HARQ-ACK information reporting method.

As shown in FIG. 3, assume that PSCCH/PSSCH in FIG. 3 is last transmission of a certain schedule, and this transmission is associated with 3 PSFCHs for HARQ-ACK information feedback. PSCCH/PSSCH starts transmission in a time unit t0. A slot in which the first PSFCH is located corresponds to a time unit t1, a slot in which the second PSFCH is located corresponds to a time unit t2, and a slot in which the third PSFCH is located corresponds to a time unit t3. If LBT succeeds on the first PSFCH, it can be determined that the time unit for the transmitting device to report HARQ-ACK information is t4; if LBT succeeds on the second PSFCH, it can be determined that the time unit for the transmitting device to report HARQ-ACK information is t5; and if LBT succeeds on the third PSFCH, it can be determined that the time unit for the transmitting device to report HARQ-ACK information is t6, where a time interval between t4 and t1, a time interval between t5 and t2, and a time interval between t6 and t3 are the second time interval which may be preconfigured or specified in the protocol.

In the SL-U system, if LBT fails on the first PSFCH and succeeds on the second PSFCH, the HARQ-ACK information is fed back to the transmitting device by the receiving device in a slot corresponding to the second PSFCH. Following the existing protocol, the slot corresponding to the second PSFCH is determined as the reference time unit corresponding to the time unit for calculating the time unit in which the transmitting device transmits HARQ-ACK information to the network device. Accordingly, if LBT fails on both the first PSFCH and the second PSFCH, and succeeds on the third PSFCH, following the existing protocol, the reference time unit for HARQ-ACK information reporting is determined as the slot corresponding to the third PSFCH.

From above, when LBT succeeds on different PSFCHs, different sending time units for transmitting HARQ-ACK information may be determined. In this case, the network device is actually unable to determine in which receiving time unit the HARQ-ACK information is received.

In the embodiments of the present disclosure, a terminal device can determine a reference time unit based on the scheduling information. The reference time unit is uniquely determined, and thus the sending time unit for transmitting the HARQ-ACK information can be uniquely determined. Specifically, the terminal device can uniquely determine the reference time unit based on the time unit where the last PSFCH corresponding to the last transmission resource is located, or the terminal device can uniquely determine the reference time unit based on a time unit where a certain transmission resource is located and a first time interval. Accordingly, the network device uniquely determines the reference time unit based on the time unit where the last PSFCH corresponding to the last transmission resource is located, or the network device uniquely determines the reference time unit based on a time unit where a certain transmission resource is located and the first time interval. From above, the terminal device and the network device can use the same rule to uniquely determine the sending time unit, thereby ensuring that the sending time unit corresponding to the terminal device and the receiving time unit corresponding to the network device are the same time unit, which avoids that the network device may need to receive the same HARQ-ACK information in multiple time units, and thus reduces complexity of monitoring HARQ-ACK information by the network device.

In order to clarify the objects, characteristics and advantages of the disclosure, embodiments of present disclosure will be described in detail in conjunction with accompanying drawings.

Some terms involved in the embodiments of the present disclosure are explained to facilitate understanding by those skilled in the art.

A terminal device in the embodiments of the present disclosure is a device with wireless communication functions, which may be a terminal, a User Equipment (UE), a Mobile Station (MS), Mobile Terminal (MT)), an access terminal device, a vehicle-mounted terminal device, an industrial control terminal device, a UE unit, a UE station, a mobile station, a remote station, a remote terminal device, a mobile device, a UE terminal device, a wireless communication device, a UE agent or UE device. The terminal device may be fixed or mobile. It should be noted that the terminal device may support at least one radio communication technology, such as Long Term Evolution (LTE) or New Radio (NR). For example, the terminal device may be a mobile phone, a pad, a desktop computer, a laptop computer, an all-in-one computer, a vehicular terminal, a Road Side Unit (RSU), a Virtual Reality (VR) terminal device, an Augmented Reality (AR) terminal device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, a cellular phone, a cordless phone, a Session Initiation Protocol (SIP) telephone, Wireless Local Loop (WLL) station, a Personal Digital Assistant (PDA), a handheld device with wireless communication functions, a computing device or other processing devices connected to a wireless modem, a wearable device, a terminal device in future mobile communication networks, or a terminal device in a future evolved Public Land Mobile Networks (PLMN). In some embodiments, the terminal device may be a device with transceiver functions, such as a chip system, where the chip system may include chips and may also include other discrete devices.

A network device in the embodiments of the present disclosure is a device that provides wireless communication functions for terminals, and may also be called a Radio Access Network (RAN) device or an access network element. The network device can support at least one radio communication technology, such as LTE or NR. For example, the network device includes but is not limited to next-generation node B (gNB), evolved node B (eNB), Radio Network Controller (RNC), node B (NB), Base Station Controller (BSC), Base Transceiver Station (BTS), home node B (for example, home evolved node B or home node B (HNB)), Baseband Unit (BBU), Transmission and Reception Point (TRP), Transmitting Point (TP), mobile switching center, etc. in 5th-generation (5G) mobile communication systems. The network device may also be a wireless controller, a Centralized Unit (CU), and/or a Distributed Unit (DU) in a Cloud Radio Access Network (CRAN) scenario. Or the network device may be a relay station, an access point, a vehicular device, a terminal device, a wearable device or a network device in future mobile communications or in future evolved PLMNs. In some embodiments, the network device may also be a device with a wireless communication function for a terminal device, such as a chip system. For example, the chip system may include chips, and may also include other discrete devices.

In some embodiments, the network device may also communicate with an Internet Protocol (IP) network, such as the Internet, a private IP network or other data networks.

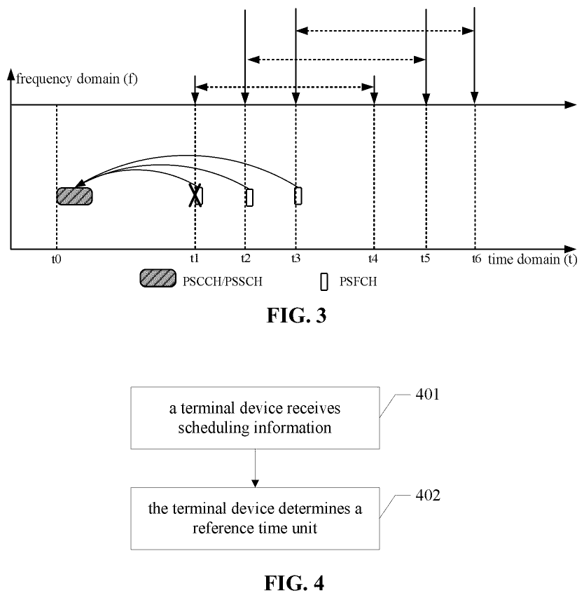

In an embodiment, a communication method is provided. Referring to FIG. 4, details of the method are provided via specific steps below.

The communication method provided in the embodiments of the present disclosure may be applied in a technical field of Vehicle-to-Everything (V2X). Referring to FIG. 5, FIG. 5 is a diagram of an application scenario according to an embodiment.

It should be noted that embodiments of the present disclosure may also be applied to NR V2X and other scenarios that face similar problems, such as Device-to-Device (D2D) or cellular networks.

In some embodiments, the method including 401 and 402 may be performed by a chip with a data processing function in a terminal device, or by a chip module containing a chip with a data processing function in a terminal device. Hereinafter, the terminal device, unless otherwise specified, is a transmitting device in a sidelink communication process.

In 401, a terminal device receives scheduling information.

In some embodiments, the scheduling information may be transmitted to the terminal device by a network device, and indicates one or more transmission resources of a sidelink. Each of the one or more transmission resources is associated with at least two PSFCHs.

For example, each transmission resource may be associated with three PSFCHs which are distributed in different slots.

In 402, the terminal device determines a reference time unit.

In some embodiments, the terminal device may determine the reference time unit based on the scheduling information. The reference time unit is used to determine a sending time unit which is a time unit for the terminal device to transmit HARQ-ACK information to the network device.

In some embodiments, the sending time unit may be determined based on the reference time unit and a preset second time interval. The second time interval may be configured by the network device through high-level signaling which may be RRC signaling.

In some embodiments, the reference time unit may be determined based on a time unit where a certain PSFCH corresponding to one or more transmission resources indicated by the scheduling information is located.

If the scheduling information indicates one transmission resource, the reference time unit may be a time unit in which a certain PSFCH corresponding to the transmission resource is located. If the scheduling information indicates multiple transmission resources, the reference time unit may be a time unit where a certain PSFCH corresponding to a certain transmission resource among the multiple transmission resources is located.

That is, the reference time unit may be a time unit in which a certain PSFCH corresponding to any transmission resource is located.

Specifically, a first PSFCH may be a first PSFCH corresponding to a certain transmission resource, or a last PSFCH corresponding to a certain transmission resource, or any PSFCH except the first PSFCH and last PSFCH corresponding to a certain transmission resource.

In some embodiments, the reference time unit may be a first PSFCH corresponding to a last transmission resource, where the first PSFCH corresponding to the last transmission resource is a last PSFCH of at least two PSFCHs corresponding to the transmission resource.

In other words, regardless of whether LBT is successful on multiple PSFCHs corresponding to the multiple transmission resources indicated by the scheduling information, the time unit where the last PSFCH corresponding to the last transmission resource is located serves as the reference time unit.

For example, the scheduling information indicates 3 transmission resources each of which is associated with 3 PSFCHs. The reference time unit is a time unit where the first PSFCH corresponding to the second transmission resource is located.

For another example, the scheduling information indicates 2 transmission resources each of which is associated with 3 PSFCHs. The reference time unit is a time unit where the third PSFCH (i.e., the last PSFCH corresponding to the last transmission resource) corresponding to the second transmission resource (i.e., the last transmission resource) is located.

In some embodiments, the time unit may be represented by any one of slots, symbols or subframes.

That is, the reference time unit may be represented by any one of slots, symbols or subframes, and the sending time unit may also be represented by any one of slots, symbols or subframes.

A representation form of the reference time unit and a representation form of the sending time unit may be the same or different.

For example, the reference time unit is represented by a slot, and the sending time unit is represented by a symbol. For another example, both the reference time unit and the sending time unit are represented by slots.

Take the reference time unit represented by a slot as an example.

The scheduling information is set to indicate 2 transmission resources each of which is associated with 3 PSFCHs. A slot in which the first PSFCH corresponding to the last transmission resource (i.e., the second transmission resource in sequence) is located is determined as the reference time unit. Alternatively, a slot in which the last PSFCH corresponding to the last transmission resource is located is determined as the reference time unit.

For another example, the scheduling information is set to indicate 2 transmission resources each of which is associated with 3 PSFCHs. A symbol where the last PSFCH corresponding to the last transmission resource is located is determined as the reference time unit.

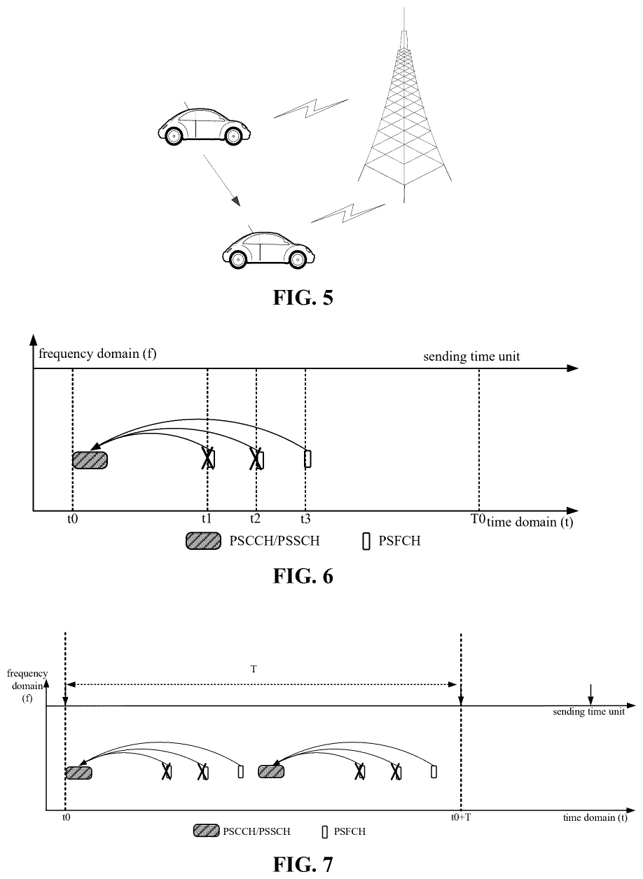

Referring to FIG. 6, FIG. 6 is a schematic diagram of a time sequence relationship between acquisition and reporting of HARQ-ACK information according to an embodiment.

In FIG. 6, PSCCH/PSSCH corresponds to last transmission indicated by scheduling information, and the network device configures 3 PSFCHs (time units corresponding to slots where the 3 PSFCHs are located are t1, t2 and t3 respectively) for the last transmission for HARQ-ACK information feedback, and determines that the reference time unit is a slot corresponding to the last PSFCH (i.e., the slot corresponding to time unit t3). The HARQ-ACK information is fed back to the network device by the transmitting device in the sending time unit TO.

In the above embodiment, specific implementation of determining the reference time unit through the time unit where the PSFCH is located is introduced.

In some embodiments, the reference time unit may also be determined based on a preset first time interval and a time unit where any transmission resource indicated by the scheduling information is located.

In some embodiments, the transmission resource used by the reference time unit may be a first transmission resource indicated by the scheduling information, a last transmission resource indicated by the scheduling information, or other transmission resources indicated by the scheduling information.

In some embodiments, the first time interval may be a preconfigured fixed value. For example, the first time interval is preconfigured to be 20 slots. For another example, the first time interval is 10 symbols in length.

Alternatively, the first time interval may be configured by the network device. For example, the network device configures the first time interval through high-layer signaling which may be Radio Resource Control (RRC) signaling. For example, it is indicated that the first time interval is 10 slots through RRC signaling.

Alternatively, the network device may configure a set of optional durations for the terminal device through RRC signaling in advance, and indicate the selected specific duration through indication information. The indication information may be Downlink Control Information (DCI) or a Media Access Control (MAC) Control Element (CE).

For example, four optional durations are configured for the terminal device through RRC signaling, where duration 1 corresponds to 5 slots, duration 2 corresponds to 10 slots, duration 3 corresponds to 15 slots, and duration 4 corresponds to 20 slots. The network device transmits the indication information through DCI which has a dedicated bit field set therein. Length of the dedicated bit field is 2 bits. When a value of the bit field is 00, it indicates duration 1, when the value of the bit field is 01, it indicates duration 2, when the value of the bit field is 10, it indicates duration 3, and when the value of the bit field is 11, it indicates duration 4.

It could be understood that the indication information may also be other types of information, as long as it can serve a function of indicating a specific duration.

Referring to FIG. 7, FIG. 7 is a schematic diagram of a time sequence relationship between acquisition and reporting of HARQ-ACK information according to an embodiment.

As shown in FIG. 7, two times of transmission are indicated in one schedule, and the network device configures 3 PSFCHs for HARQ-ACK information feedback in each transmission. A starting time unit of the time unit where the first transmission resource in this schedule is located is t0, the first time interval is T, and the reference time unit is (t0+T).

In some embodiments, the reference time unit is determined through the time unit where the PSFCH is located, which requires minor changes to the existing protocol, but flexibility is relatively low.

However, determining the reference time unit based on a time unit where a certain transmission resource is located and the first time interval may be more flexible, as the first time interval can be set according to requirements.

From above, in specific applications, the method of determining the reference time unit may be selected according to requirements.

In addition, it should be noted that the method of determining the reference time unit is not limited to the method provided above, as long as the terminal device and the network device can uniquely determine the reference time unit/sending time unit.

In some embodiments, following determining the sending time unit, the terminal device may transmit the HARQ-ACK information to the network device in the sending time unit. The terminal device transmitting the HARQ-ACK information to the network device may refer to the terminal device reporting the HARQ-ACK information to the network device.

In the embodiments of the present disclosure, the network device can determine the reference time unit based on the scheduling information, and further determine the sending time unit. The network device can receive the HARQ-ACK information from the terminal device in the sending time unit.

Specifically, which method is specifically used to determine the reference time unit may be pre-configured in a protocol. In other words, the protocol stipulates which method is used to determine the reference time unit, and both the terminal device and the network device use the method specified in the protocol to determine the reference time unit.

For example, it is stipulated in advance in the protocol that a slot of the last PSFCH corresponding to the last transmission resource in a scheduling serves as the reference time unit. A slot of the last PSFCH corresponding to the last transmission resource can be uniquely and implicitly determined based on parameters configured by the network device and a corresponding mapping rule, and the second time interval can also be configured by the network device or be preset. Accordingly, the network device learns the sending time unit in which the terminal device transmits the HARQ-ACK information based on the reference time unit and the second time interval.

For another example, it is stipulated in advance in the protocol that the reference time unit is determined based on a slot where the first transmission resource is located and the first time interval. As transmission resources are scheduled by a network, the network device can learn a slot where the first transmission resource is located. In addition, the first time interval is configured by the network or is a fixed value preset, thus, the network device determines the reference time unit based on the slot where the first transmission resource is located and the first time interval, and further determines the sending time unit in which the terminal device transmits the HARQ-ACK information based on the reference time unit and the first time interval.

In some embodiments, as an optional operation, the terminal device may agree with the network device in advance on which method to be used for determining the reference time unit.

In summary, the terminal device and the network device use a same solution to uniquely determine the sending time unit, thereby ensuring that the terminal device and the network device transmit and receive the HARQ-ACK information respectively in the same time unit, thereby avoiding that the network device may need to receive the same HARQ-ACK information in multiple time units, and reducing complexity of monitoring the HARQ-ACK information by the network device.

Referring to FIG. 8, FIG. 8 is a flow chart of a communication method according to an embodiment.

In some embodiments, the method including 801 and 802 may be performed by a chip with a data processing function in a network device, or by a chip module containing a chip with a data processing function in a network device.

In 801, a network device transmits scheduling information.

In some embodiments, before this data transmission, the network device transmits the scheduling information to a terminal device. The scheduling information indicates one or more transmission resources of a sidelink. Each of the one or more transmission resources corresponds to at least two PSFCHs.

Referring to FIG. 7, in an embodiment, each transmission resource is associated with three PSFCHs which are distributed in different slots.

In 802, the network device determines the reference time unit.

In the embodiments of the present disclosure, the network device can determine the reference time unit based on the scheduling information, and further determine the sending time unit for the terminal device to transmit the HARQ-ACK information. The network device may receive the HARQ-ACK information from the terminal device in the receiving time unit (the receiving time unit is the same time unit as the sending time unit in which the terminal device transmits the HARQ-ACK information).

Specifically, which method is specifically used to determine the reference time unit may be pre-configured in a protocol. In other words, the protocol stipulates which method is used to determine the reference time unit, and both the terminal device and the network device use the method specified in the protocol to determine the reference time unit.

For example, it is stipulated in advance in the protocol that a slot of the last PSFCH corresponding to the last transmission resource in a scheduling serves as the reference time unit. A slot of the last PSFCH corresponding to the last transmission resource can be uniquely and implicitly determined based on parameters configured by the network device and a corresponding mapping rule, and the second time interval can also be configured by the network device or be preset. Accordingly, the network device learns the sending time unit in which the terminal device transmits the HARQ-ACK information based on the reference time unit and the second time interval.

For another example, it is stipulated in advance in the protocol that the reference time unit is determined based on a slot where the first transmission resource is located and the first time interval. As transmission resources are scheduled by a network, the network device can learn a slot where the first transmission resource is located. In addition, the first time interval is configured by the network or is a fixed value preset, thus, the network device determines the reference time unit based on the slot where the first transmission resource is located and the first time interval, and further determines the sending time unit in which the terminal device transmits the HARQ-ACK information based on the reference time unit and the second time interval.

In some embodiments, as an optional operation, the terminal device may agree with the network device in advance on which method to be used for determining the reference time unit.

In some embodiments, after determining the receiving time unit, the network device may receive the HARQ-ACK information from the terminal device in the receiving time unit.

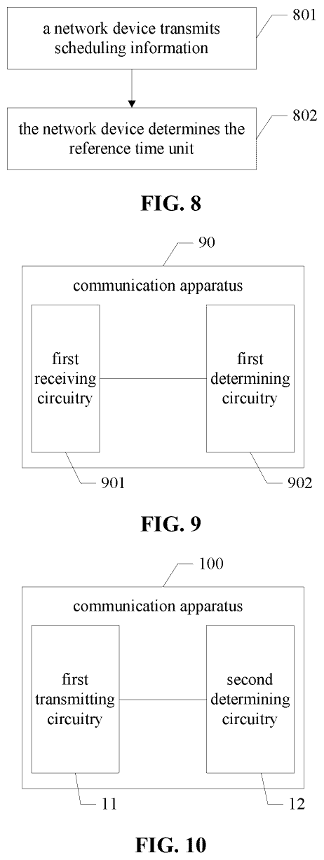

FIG. 9 is a block diagram of a communication apparatus 90 according to an embodiment. The communication apparatus 90 includes a first receiving circuitry 901 and a first determining circuitry 902.

The first receiving circuitry 901 is configured to receive scheduling information, where the scheduling information indicates a transmission resource of a sidelink, and the transmission resource corresponds to at least two PSFCHs.

The first determining circuitry 902 is configured to determine a reference time unit, where the reference time unit is used to determine a sending time unit of HARQ-ACK information, and the HARQ-ACK information indicates a reception status of the sidelink.

In some embodiments, more details of the first receiving circuitry 901 and the first determining circuitry 902 may be referred to the above descriptions of 401 and 402, and are not repeated here.

In some embodiments, the communication apparatus 90 may correspond to a chip with a data processing function in a terminal device, or to a chip module containing a chip with a data processing function in a terminal device, or to a terminal device.

FIG. 10 is a block diagram of a communication apparatus 100 according to an embodiment. The communication apparatus 100 includes a first transmitting circuitry 11 and a second determining circuitry 12.

The first transmitting circuitry 11 is configured to transmit scheduling information, where the scheduling information indicates a transmission resource of a sidelink, and the transmission resource corresponds to multiple PSFCHs.

The second determining circuitry 12 is configured to determine a reference time unit, where the reference time unit is used to determine a sending time unit of HARQ-ACK information, and the HARQ-ACK information indicates a reception status of the sidelink.

In some embodiments, more details of the first transmitting circuitry 11 and the second determining circuitry 12 may be referred to the above descriptions of 801 and 802, and are not repeated here.

In some embodiments, the above communication apparatus 100 may correspond to a chip with a data processing function in a network device, or to a chip module containing a chip with a data processing function in a network device, or to a network device.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, wherein when the computer instructions are executed by a processor, the above method including 401 and 402 or the above method including 801 and 802 is performed.

In an embodiment of the present disclosure, a communication apparatus including a memory and a processor is provided, wherein the memory has computer instructions stored therein, and when the processor executes the computer instructions, the above method including 401 and 402 or the above method including 801 and 802 is performed.

Those skilled in the art could understand that all or part of steps in the various methods in the above embodiments can be completed by instructing relevant hardware through a program, and the program can be stored in any computer-readable storage medium which includes a ROM, a RAM, a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A communication method, comprising:
receiving scheduling information, wherein the scheduling information indicates a transmission resource of a sidelink, and the transmission resource corresponds to at least two Physical Sidelink Feedback CHannels (PSFCHs); and
determining a reference time unit, wherein the reference time unit is used to determine a sending time unit of Hybrid Automatic Repeat reQuest-ACKnowledgement (HARQ-ACK) information, and the HARQ-ACK information indicates a reception status of the sidelink.

2. The communication method according to claim 1, wherein the reference time unit is a time unit where a first PSFCH is located, and the first PSFCH is one of the at least two PSFCHs.

3. The communication method according to claim 2, wherein the first PSFCH is the last PSFCH among the at least two PSFCHs.

4. The communication method according to claim 1, wherein said determining the reference time unit comprises:
determining the reference time unit based on the transmission resource indicated by the scheduling information and a first time interval.

5. The communication method according to claim 4, wherein the transmission resource is a first transmission resource indicated by the scheduling information.

6. The communication method according to claim 4, wherein the first time interval is configured by a network device, or the first time interval is a preset value.

7. The communication method according to claim 6, wherein the first time interval is configured by the network device, and said configuring the first time interval by the network device comprises:
configuring one or more values through RRC signaling, and/or
instructing, through MAC CE or DCI, the RRC signaling to configure one of the one or more values.

8. The communication method according to claim 1, further comprising:
determining the sending time unit of the HARQ-ACK information based on the reference time unit; and
transmitting the HARQ-ACK information in the sending time unit.

9-17. (canceled)

18. A non-volatile or non-transitory computer readable storage medium storing one or more programs, the one or more programs comprising computer instructions, which, when executed by a processor, cause the processor to:
receive scheduling information, wherein the scheduling information indicates a transmission resource of a sidelink, and the transmission resource corresponds to at least two Physical Sidelink Feedback CHannels (PSFCHs); and
determine a reference time unit, wherein the reference time unit is used to determine a sending time unit of Hybrid Automatic Repeat reQuest-ACKnowledgement (HARQ-ACK) information, and the HARQ-ACK information indicates a reception status of the sidelink.

19. A communication apparatus comprising a memory and a processor, wherein the memory stores one or more programs, the one or more programs comprising computer instructions, which, when executed by the processor, cause the processor to:
receive scheduling information, wherein the scheduling information indicates a transmission resource of a sidelink, and the transmission resource corresponds to at least two Physical Sidelink Feedback CHannels (PSFCHs); and
determine a reference time unit, wherein the reference time unit is used to determine a sending time unit of Hybrid Automatic Repeat reQuest-ACKnowledgement (HARQ-ACK) information, and the HARQ-ACK information indicates a reception status of the sidelink.

20. The communication apparatus according to claim 19, wherein the reference time unit is a time unit where a first PSFCH is located, and the first PSFCH is one of the at least two PSFCHs.

21. The communication apparatus according to claim 20, wherein the first PSFCH is the last PSFCH among the at least two PSFCHs.

22. The communication apparatus according to claim 19, wherein the processor is further caused to:
determine the reference time unit based on the transmission resource indicated by the scheduling information and a first time interval.

23. The communication apparatus according to claim 22, wherein the transmission resource is a first transmission resource indicated by the scheduling information.

24. The communication apparatus according to claim 22, wherein the first time interval is configured by a network device, or the first time interval is a preset value.

25. The communication apparatus according to claim 24, wherein the first time interval is configured by the network device, and said configuring the first time interval by the network device comprises:
configuring one or more values through RRC signaling, and/or
instructing, through MAC CE or DCI, the RRC signaling to configure one of the one or more values.

26. The communication apparatus according to claim 23, wherein the first time interval is configured by a network device, or the first time interval is a preset value.

27. The communication apparatus according to claim 19, wherein the processor is further caused to:
determine the sending time unit of the HARQ-ACK information based on the reference time unit; and
transmit the HARQ-ACK information in the sending time unit.

28. The communication method according to claim 5, wherein the first time interval is configured by a network device, or the first time interval is a preset value.

29. The communication method according to claim 28, wherein the first time interval is configured by the network device, and said configuring the first time interval by the network device comprises:
configuring one or more values through RRC signaling, and/or
instructing, through MAC CE or DCI, the RRC signaling to configure one of the one or more values.
